(19) United States
(12) Patent Application Publication
(10) Pub. No.: US 2023/0186111 A1
(43) Pub. Date: Jun. 15, 2023

(54) COGNITIVE PLATFORM FOR KNOWLEDGE EXTRACTION FROM HETEROGENOUS DATA SOURCES AND THE METHOD THEREOF

(71) Applicant: INFOSYS LIMITED, Bangalore (IN)

(72) Inventors: Ramaswami Mohandoss, Chenna (IN); Rajan PADMANABHAN, Plano, TX (US)

(21) Appl. No.: 17/548,117

(22) Filed: Dec. 10, 2021

(51) Int. Cl. G06N 5/02; G06F 40/279; G06F 40/169; G06Q 30/02

(52) U.S. Cl. CPC G06N 5/022; G06F 40/279; G06F 40/169; G06Q 30/0201

(57) ABSTRACT

Provided is a method and platform for knowledge extraction from multiple data sources. The disclosure includes extracting entities from the data sources and synthesizing the same. They are then classified into concepts or connectors. Based on the extracted data and identified entities, knowledge model is created. The knowledge model can show the relation between the concept and the connectors. Once the knowledge model is created, a second data source is used. Using the knowledge model and second data source, data records are created which can be used to prepare the knowledge graph.

### FIELD

The present disclosure relates to autonomous knowledge extraction from one or more heterogeneous data sources. More specifically it relates to generating knowledge model and graph from structured or unstructured data sources.

### BACKGROUND

Data organized in a form of a knowledge graph can immensely benefit an enterprise. An effective knowledge graph requires a holistic knowledge model to harvest knowledge from data. A holistic knowledge model is not only broad from an industry standpoint but also captures the enterprise's unique positioning of its products and services among its customers. Such a well-defined knowledge model would act as a lens through which the enterprise could perceive the world through data. A knowledge graph is a structured graphical representation of semantic knowledge and relations where nodes in the graph represent the entities and the edges represent the relation between them. A knowledge model focusses on what inferences shall be made from a data.

### SUMMARY

Provided is a method for knowledge extraction from heterogeneous data sources which comprises extracting one or more concepts from a first one or more heterogeneous data sources, using a first one or more pre-existing knowledge structure, and identifying relation between the extracted concepts using the first data sources and the pre-existing first knowledge structure. A first knowledge structure is created using the identified relations, and one or more entities are extracted from a second one or more data source. The extracted entities are mapped to the extracted concepts and the identified relations, using the created first knowledge structure, and the second data source is associate with the first data source. The mapping of the entities is converted into one or more data structures and a second knowledge structure is created from the converted data structures.

Provided is a cognitive platform for knowledge extraction from heterogeneous data sources comprising a processor and a memory which has instruction to cause the platform to extract one or more concepts from a first one or more heterogeneous data sources, using a first one or more pre-existing knowledge structure, and identify relation between the extracted concepts using the first data sources and the pre-existing first knowledge structure. A knowledge structure is created using the identified relations, and one or more entities are extracted from a second data source. The extracted entities are mapped to the extracted concepts and the identified relations, using the earlier first knowledge structure. The second data source is associate with the first data source. The mapping of the entities is converted into one or more data structures and; another knowledge structure is created from the converted data structures.

Provided is a non-transitory computer readable medium for knowledge extraction from heterogeneous data sources comprising a processor and a memory which has instruction to cause the platform to extract one or more concepts from a first one or more heterogeneous data sources, using a first one or more pre-existing knowledge structure, and identify relation between the extracted concepts using the first data sources and the pre-existing first knowledge structure. A knowledge structure is created using the identified relations, and one or more entities are extracted from a second data source. The extracted entities are mapped to the extracted concepts and the identified relations, using the earlier first knowledge structure. The second data source is associate with the first data source. The mapping of the entities is converted into one or more data structures and; another knowledge structure is created from the converted data structures.

### BRIEF DESCRIPTION OF THE DRAWINGS

FIG. 1 relates to a general-purpose computing system to implement an embodiment of the process as disclosed;

FIG. 2 relates to a flowchart explaining an embodiment of the process as disclosed;

FIG. 3 relates to an architecture/system for implementing an embodiment of the process as disclosed; and

FIG. 4 describes an example of an embodiment of a knowledge model and a knowledge graph.

### DETAILED DESCRIPTION

In an embodiment, the present disclosure effectively helps harvest knowledge into a knowledge model, along with effectively realizing the knowledge graph. A knowledge graph requires a holistic knowledge model to harvest knowledge from data. Knowledge models are different from data models. While the data model would define the information to be captured through a data structure, a knowledge model would focus on the inferences made from the data.

For the purpose of this document an explanation of the terms used in this document is provided below. This is only for the purpose of illustration. Various embodiments and appropriate interpretation of the terms can be implied as the per the understanding of the disclosed technology.

Concept—concepts may be extracted from one or more structured or unstructured data or knowledge sources. Concepts may either imply a subject or the characteristics of a subject related to which a user needs a knowledge model or a graph. For instance, a subject called apparel can itself be a concept along with the various characteristics related to the apparel. Some examples are color, size, texture, category etc.

Connector—Connectors imply how concepts may be related to one another. For instance, color of a sweatshirt, size of a dress, customer likes a dress etc.

Domain—Domain may be a collection of possible values that belong to a concept or a connector. Size of the domain will depend on the kind of the concept or a connector. Some domains are large (like customer identifiers) and some small (like color). Each possible value in a domain is an instance of the concept or the connector. For instance large, medium, small maybe the domain for the concept ‘size’; Adam, Smith, Sriram, or employee numbers maybe the domain for the concept ‘customer’.

Entity—An entity maybe a portion of a raw text extracted from the data source, which may relate to a subject or any other part of speech related to the subject. Depending on the context, an entity may either get mapped to a concept or a connector or an instance of a concept or an instance of a connector. For instance, a style id like ‘polo neck’, ‘tight fit’, or a person like ‘john’ etc. An embodiment of the present disclosure discloses autonomous identification of concepts and connectors from unstructured text data, using various components as will be elaborated in coming paragraphs. The disclosure further provides ability to harvest knowledge from unstructured text through a custom knowledge model.

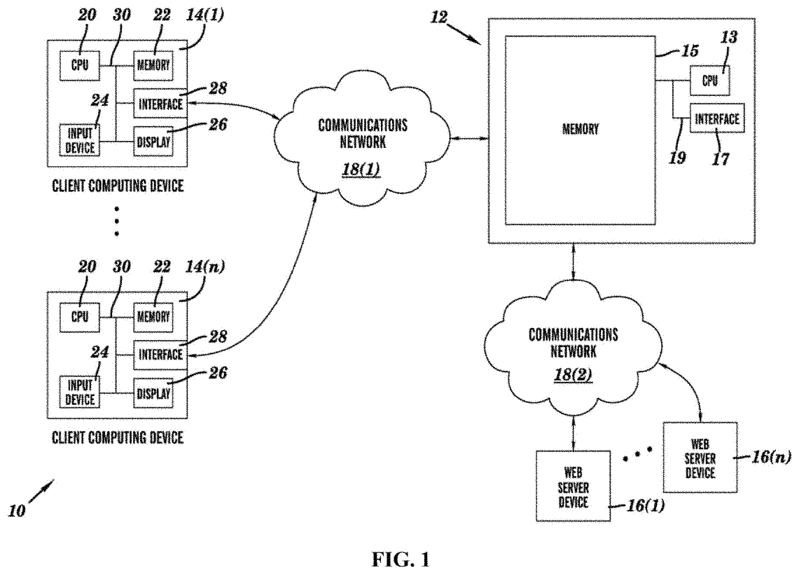

An exemplary environment 10 with a knowledge extraction processing system 12 configured to extract and process information, is illustrated in FIG. 1, although this technology can be implemented on other types of devices, such as one of the web server devices 16(1)-16(n), or any other server computing apparatus configured to receive and process hypertext transfer protocol (HTTP) requests, by way of example only. The exemplary environment 10 includes an knowledge processing system 12, client devices 14(1)-14(n), the web server devices 16(1)-16(n), and communication networks 18(1)-18(2), although other numbers and types of systems, devices, and/or elements in other configurations and environments with other communication network topologies can be used. This technology provides several advantages including providing a method, computer readable medium and an apparatus that can provide knowledge processing system.

Referring more specifically to FIG. 1, the knowledge processing system 12 may include a central processing unit (CPU) or processor 13, a memory 15, and an interface system 17 which are coupled together by a bus 19 or other link, although other numbers and types of components, parts, devices, systems, and elements in other configurations and locations can be used. The processor 13 in the knowledge processing system 12 executes a program of stored instructions for one or more aspects of the present disclosure as described and illustrated by way of the embodiments herein, although the processor could execute other numbers and types of programmed instructions.

The memory 15 in the knowledge processing system 12 stores these programmed instructions for one or more aspects of the present invention as described and illustrated herein, although some or all of the programmed instructions could be stored and/or executed elsewhere. A variety of different types of memory storage devices, such as a random access memory (RAM) or a read only memory (ROM) in the system or a floppy disk, hard disk, CD ROM, DVD ROM, or other computer readable medium which is read from and/or written to by a magnetic, optical, or other reading and/or writing system that is coupled to the processor 13, can be used for the memory 15 in the web content optimization computing apparatus 12.

The interface system 17 in the knowledge processing system 12 is used to operatively couple and communicate between the knowledge processing system 12 and the client devices 14(1)-14(n) and the web server devices 16(1)-16(n) via the communication networks 18(1) and 18(2), although other types and numbers of communication networks with other types and numbers of connections and configurations can be used. By way of example only, the communication networks 18(1) and 18(2) can use TCP/IP over Ethernet and industry-standard protocols, including HTTP, HTTPS, WAP, and SOAP, although other types and numbers of communication networks, such as a direct connection, a local area network, a wide area network, modems and phone lines, e-mail, and wireless and hardwire communication technology, each having their own communications protocols, can be used.

Each of the client devices 14(1)-14(n) enables a user to request, receive, and interact with web pages from one or more web sites hosted by the web server devices 16(1)-16(n) through the knowledge processing system 12 via one or more communication networks 18(1). Although multiple client devices 14(1)-14(n) are shown, other numbers and types of user computing systems could be used. In one example, the client devices 14(1)-14(n) comprise smart phones, personal digital assistants, computers, or mobile devices with Internet access that permit a website form page or other retrieved web content to be displayed on the client devices 14(1)-14(n).

Each of the client devices 14(1)-14(n) in this example is a computing device that includes a central processing unit (CPU) or processor 20, a memory 22, user input device 24, a display 26, and an interface system 28, which are coupled together by a bus 30 or other link, although one or more of the client devices 14(1)-14(n) can include other numbers and types of components, parts, devices, systems, and elements in other configurations. The processor 20 in each of the client devices 14(1)-14(n) executes a program of stored instructions for one or more aspects of the present invention as described and illustrated herein, although the processor could execute other numbers and types of programmed instructions.

The memory 22 in each of the client devices 14(1)-14(n) stores these programmed instructions for one or more aspects of the present invention as described and illustrated herein, although some or all of the programmed instructions could be stored and/or executed elsewhere. A variety of different types of memory storage devices, such as a random access memory (RAM) or a read only memory (ROM) in the system or a floppy disk, hard disk, CD ROM, or other computer readable medium which is read from and/or written to by a magnetic, optical, or other reading and/or writing system that is coupled to processor 20 can be used for the memory 22 in each of the client devices 14(1)-14(n).

The user input device 24 in each of the client devices 14(1)-14(n) is used to input selections, such as requests for a particular website form page or to enter data in fields of a form page, although the user input device could be used to input other types of data and interact with other elements. The user input device can include keypads, touch screens, and/or vocal input processing systems, although other types and numbers of user input devices can be used.

The display 26 in each of the client devices 14(1)-14(n) is used to show data and information to the user, such as website or application page by way of example only. The display in each of the client devices 14(1)-14(n) can be a mobile phone screen display, although other types and numbers of displays could be used depending on the particular type of client device 14(1)-14(n).

The interface system 28 in each of the client devices 14(1)-14(n) is used to operatively couple and communicate between the client devices 14(1)-14(n), the knowledge processing system 12, and the web server devices 16(1)-16(n) over the communication networks 18(1) and 18(2), although other types and numbers of communication networks with other types and numbers of connections and configurations can be used.

The web server devices 16(1)-16(n) provide web content such as one or more pages from one or more web sites for use by one or more of the client devices 14(1)-14(n) via the web content optimization computing apparatus 12, although the web server devices 16(1)-16(n) can provide other numbers and types of applications and/or content and can provide other numbers and types of functions. Although the web server devices 16(1)-16(n) are shown for ease of illustration and discussion, other numbers and types of web server systems and devices can be used.

Each of the web server devices 16(1)-16(n) include a central processing unit (CPU) or processor, a memory, and an interface system which are coupled together by a bus or other link, although each of the web server devices 16(1)-16(n) could have other numbers and types of components, parts, devices, systems, and elements in other configurations and locations. The processor in each of the web server devices 16(1)-16(n) executes a program of stored instructions one or more aspects of the present invention as described and illustrated by way of the embodiments herein, although the processor could execute other numbers and types of programmed instructions.

The memory in each of the web server devices 16(1)-16(n) stores these programmed instructions for one or more aspects of the present invention as described and illustrated by way of the embodiments described and illustrated herein, although some or all of the programmed instructions could be stored and/or executed elsewhere. A variety of different types of memory storage devices, such as a random access memory (RAM) or a read only memory (ROM) in the system or a floppy disk, hard disk, CD ROM, DVD ROM, or other computer readable medium which is read from and/or written to by a magnetic, optical, or other reading and/or writing system that is coupled to the processor, can be used for the memory in each of the web server devices 16(1)-16(n).

The interface system in each of the web server devices 16(1)-16(n) is used to operatively couple and communicate between the web server devices 16(1)-16(n), the knowledge processing system 12, and the client devices 14(1)-14(n) via the communication networks 18(1) and 18(2), although other types and numbers of communication networks with other types and numbers of connections and configurations can be used.

Although embodiments of the knowledge processing system 12, the client devices 14(1)-14(n), and the web server devices 16(1)-16(n), are described and illustrated herein, each of the client devices 14(1)-14(n), the knowledge processing system 12, and the web server devices 16(1)-16(n), can be implemented on any suitable computer system or computing device. It is to be understood that the devices and systems of the embodiments described herein are for exemplary purposes, as many variations of the specific hardware and software used to implement the embodiments are possible, as will be appreciated by those skilled in the relevant art(s).

Furthermore, each of the systems of the embodiments may be conveniently implemented using one or more general purpose computer systems, microprocessors, digital signal processors, and micro-controllers, programmed according to the teachings of the embodiments, as described and illustrated herein, and as will be appreciated by those ordinary skill in the art.

In addition, two or more computing systems or devices can be substituted for any one of the systems in any of the embodiments. Accordingly, principles and advantages of distributed processing, such as redundancy and replication also can be implemented, as desired, to increase the robustness and performance of the devices and systems of the embodiments. The embodiments may also be implemented on computer system or systems that extend across any suitable network using any suitable interface mechanisms and communications technologies, including by way of example only telecommunications in any suitable form (e.g., voice and modem), wireless communications media, wireless communications networks, cellular communications networks, G3 communications networks, Public Switched Telephone Network (PSTNs), Packet Data Networks (PDNs), the Internet, intranets, and combinations thereof.

The embodiments may also be embodied as a non-transitory computer readable medium having instructions stored thereon for one or more aspects of the present invention as described and illustrated by way of the embodiments herein, as described herein, which when executed by a processor, cause the processor to carry out the steps necessary to implement the methods of the embodiments, as described and illustrated herein.

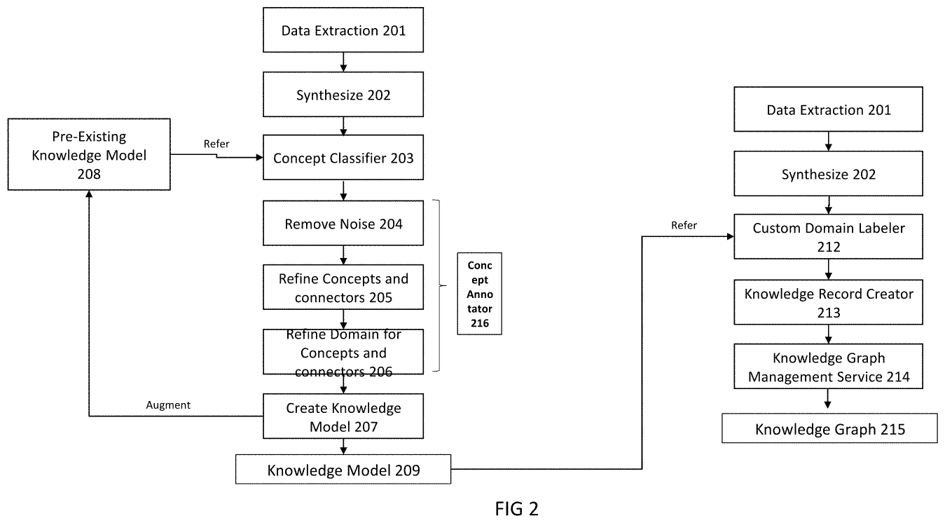

An embodiment of the process will now be explained along with FIG. 2. In an embodiment text data may be extracted from one or more data sources (201). The data sources may be structured or unstructured. These may also be raw data sources. Such instances of data sources maybe pdf files, word documents, websites, databases and knowledge repositories and sources. The data sources may also be structured databases. In one embodiment a data extractor may be configured to use natural language or regular expressions and other related technologies to identify the appropriate text to be extracted. The extracted data maybe in a form of raw text, which can be processed, and information can be identified. For instance, when the data source is a webpage that is a Product detail page, the data extractor will extract only the relevant text from that webpage that is free of any advertisements that may be present in the page.

In an embodiment, the data extractor may extract only the most relevant data from the data sources, and remove everything that it may find unrelated. In a later instance, the data extractor may learn from the type of content that was extracted initially and accordingly decide the relevance.

In an embodiment the extracted data is synthesized (202), which may include tagging, parsing along with named entity recognition to enable extraction of entities from the raw extracted data. For instance, synthesized information from raw text extracted by the data extractor from a product detail page will include phrases like product available in various colors or product available in various sizes etc. In an embodiment, appropriate words will be marked as entities in these phrases. For instance, in the above phrases, following are relevant entities—product, size, color & available in.

In an embodiment, a concept classifier (203) may have components configured to classify entities as either concepts or connectors and may use natural language or regular expressions and other related technologies to perform this classification.

A pre-existing knowledge model (208) may be used to classify select entities from the synthesized data as concepts or connectors. The knowledge model may have pre-built set of concepts, connectors along with a domain for each of those concepts and connectors. To classify entities into concepts and connectors, techniques such as vector similarities, rule matching logic or any other appropriate technology may be applied. It calculates the distance between the entity and the nearest concept (or connector) either directly or through one of its domain values. For instance, a knowledge model may identify a concept called size through its domain values like Small, Medium, Large etc. The concept classifier could map an entity value ‘extra-large’ after synthesis to the concept ‘size’ after comparing it with the existing domain values in the pre-existing knowledge models. Further, the ‘extra-large’ may also get added into the domain values of ‘Size’.

In an embodiment, connectors between the extracted concepts may also be identified using the pre-existing knowledge model. For instance, let us consider a pre-built knowledge model has a connector ‘available in’ that connects ‘product’ concept with ‘size’ and ‘color’ concepts. Once concepts like product, size and color are identified from the extracted entities, connector ‘available in’ shall also be inferred.

In an embodiment, the unrequired data which could be a concept, connector or part of a concept or connector's domain which may have been extracted by the data extractor (201) or classified as an entity by the synthesizer (202) is flagged as a blacklisted word or noise (204). Noise may also include any ambiguous data, or any other unrequired text which is not relevant for the knowledge model or the knowledge graph. This data may be used to retrain the data extractor (201) component in the form of refinements through natural language or regular expressions and other related technologies.

In an embodiment, new concepts or connectors may be introduced either programmatically or by a human SME through a UI (205).

In an embodiment, the domain of a concept or a connector could be updated, deleted or augmented with a new value either programmatically or by a human (SME) through a UI (206).

In an embodiment, the data cleaning and refining as explained above may be done by a concept annotator (216). The concept annotator may further enable SMEs to identify further concepts from the data source. These further concepts may be those that were missed by using the NLP technologies, or may have been identified as relevant by the SME later. It may also include refining and adding additional connectors that relate to different concepts.

In an embodiment the process as explained herein may be controlled or assisted through a user interface (UI) or a collection of UI components. Alternatively one or more steps in the process may be automatic or implemented through AI models. These may be configured as per user requirements. Various modifications of these implementation modes may be used. Pre-existing knowledge models may learn through ML and AI technologies and enhance through the refinements of concepts and connectors.

In an embodiment once the entities are synthesized from extracted data, the entities are mapped to appropriate concepts and connectors such that the configured functionalities of concept mapper and the concept annotator are fulfilled, the mapped data along with the values maybe structured in a form of a database, or any other repository (207). Alternatively, it may be stored in a j son file, csv or an xml file or any other file format with appropriate functionalities to store the concepts and connectors. This represents a knowledge structure. It may be structured in a form of a knowledge model (209).

In an embodiment, once the knowledge model is created, one or more second data sources may be considered. The second data source maybe one or more structured or unstructured data source, and maybe related to the data sources used for extracting instances of concepts and connectors. It may be a data source carrying more specific information. For instance, for a shopping experience, the second data source may be website where users have posted reviews in a social data, blog or a product catalog.

Once the entity extraction and synthesizing is done on the second data source, the knowledge model created in the form of a j son, csv or xml file is provided as an input to a domain labeler component (212). A domain labeler component may apply word vector similarities or rule matching logic to label the entities to the nearest concept or connector. It enables map the entities to the concepts or connectors. To enable the mapping it may perform, parsing the knowledge model and the extracted entities. It may use string matching or other appropriate technologies to get closest match between them and accordingly map the entity to the concept or connector. This may provide a mapping of actual conversation of users or customers, with the concepts and connectors. For instance, if the second data source mentions,

### Mark Smith

Just bought them and I'm loving it

### Cindy

I love these types of shirts especially with one of my favorite brands, (NIKE). You will get compliments on this shirt. Quality great as expected and fits true to size. Arrived within 2 days to me.

The entities extracted would be ‘Mark’ ‘bought’ ‘Cindy’ ‘shirts’ etc. Accordingly using word vector similarities and rule matching logic, the domain labeler component labels each of the entities to the nearest concepts and connector available in the knowledge model. For instance, the entity ‘Mark’ will be mapped to the concept ‘customer’, and any entity like ‘slim fit’ or ‘XL’ will map to concepts, ‘style’ or ‘size’.

In an embodiment, once the entities are labelled to the nearest concepts or connectors, individual structured tuples of the form [<concept instance><Concept>, <connector instance><connector>, <concept instance><concept>] may be created as a knowledge record (213). In an embodiment, this knowledge record may be persisted in a database or a flat file.

In one embodiment, these knowledge records may be communicated to any Knowledge Graph Management Service (214). It may be any microservice designed to insert or update the tuples as nodes and edges in a graph store. The knowledge graph management service may convert the objects in a knowledge graph, as required by the user (215).

The above disclosure may assist any SME in an enterprise to help create a holistic Knowledge Model for any Industry segment, that can be leveraged to autonomously harvest knowledge from data. The knowledge model and knowledge graph created using this disclosure go through continuous enhancements and improvisation. And therefore may assist in improvised entity extraction along with identification of concepts and connectors. The overall knowledge harvesting may thus relieve the end users from managing the data and enabling them to make better decisions.

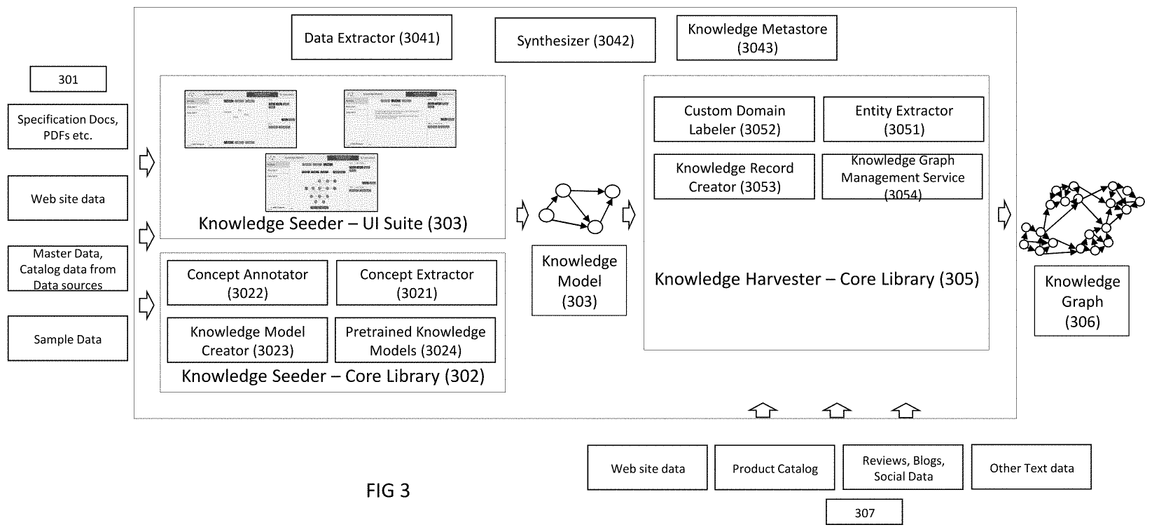

An embodiment of the system to implement the present disclosure will now be explained along with the description of FIG. 3.

In one embodiment, the system can be implemented over a network with an appropriate client server topology. The data sources that may be used in the process as explained earlier may be accessed over a network, over multiple connected devices. In one embodiment, one or more server devices may be configured to extract the data from the data sources and process the data as explained earlier. The data processing may also be implemented using distributed database or using multiple devices in a network. In an embodiment, the processing can be done using a cloud implementation.

In one embodiment a knowledge seeder may comprise of a core library (302) and a UI suite (303). The knowledge seeder may be configured to extract concepts and connectors from multiple structured or unstructured data sources (301). These data sources may be any image, video, pdfs, databases, websites etc. as available to a user. The UI suite may be configured to trigger components of the core library. In an embodiment, the core library and the UI suite may be installed in a remote device which can access the data sources (301) that may be scattered over multiple locations. Alternatively the UI suite and core library may be installed in separate devices. In an embodiment the data sources, the UI suite and the core library may be implemented over a peer-to-peer network.

In an embodiment, the core library may comprise of a concept extractor (3021). A concept extractor may further comprise a data extractor and synthesizer which may be configured appropriately to distill noise and derive potential concepts hidden in the data. The data extracted from the various data sources may comprise concepts, connectors and instances of these concepts and connectors.

In an embodiment a concept annotator (3022) may be integrated with the concept extractor. It may enable provide a simplified view of extracted raw data. On one embodiment it maybe as a word cloud of unigrams, bigrams and trigrams to help the SME identify newer concepts. It may also be any other representation as required by the users. This component will also help programmatically identify the domain for each concept and connector i.e. the list of values. The concept annotator may also refine the data, remove noises and anomalies.

In an embodiment, a knowledge model creator (3023) may use the synthesized entities along with the extracted concepts and connectors to create a knowledge model (303). It may be configured to programmatically identify potential connectors between the identified concepts. This component may also help extract the knowledge model as an external data file. The knowledge model may be prepared in the form of a j son file, or a xml, csv or any format as required by the user.

In an embodiment, the prepared knowledge model assists the concept extractor in further requirements data extraction, concept mapping, connector mapping and may be available as a pretrained knowledge model for other data extractions (3024).

In one embodiment, the knowledge model maybe persisted in a knowledge metastore (3043) which could be a data store or database or a flat file.

The knowledge model is an output provided by the knowledge seeder part of the system. The second part of the system may be referred as a knowledge harvester. The knowledge harvester may have a core library (305). The core library may have multiple data processing components such as but not limited to, an entity extractor (3051), a custom domain labeler (3052), a knowledge record creator (3053), and a knowledge graph management service (3054).

In an embodiment, the entity extractor (3051) may be configured to extract entities from raw data with the help of a data extractor and synthesizer. The raw data (307) used by the entity extractor may be multiple a little more specific data source such as reviews, blogs, social data, product catalog where there may be specific data about the entities.

In one embodiment, the entity extractor may communicate with a custom domain labeler (3052). The custom domain labeller may apply word vector similarities and rule matching logic to label the entities to the nearest concept and connector as identified from the knowledge model prepared by the knowledge seeder and provided as input to the knowledge harvester. This component also enables the mapping the entities to concepts and connectors.

In one embodiment, the labelled entity as a concept or a connector maybe transferred to the knowledge record creator (3053) which may be a configured microservice for keeping track of the extracted knowledge record as a structured tuple of the form [<concept instance><Concept>, <connector instance><connector>, <concept instance><concept>].

In one embodiment, the extracted knowledge record maybe persisted in a knowledge metastore (3043) which could be a data store or database or a flat file.

In one embodiment, the constructed data records maybe then transferred to one more microservice knowledge graph management service (3054) designed to insert or update triple objects into a knowledge graph store.

The knowledge harvester accordingly provides a knowledge graph (306) as output, based on the knowledge graph management services.

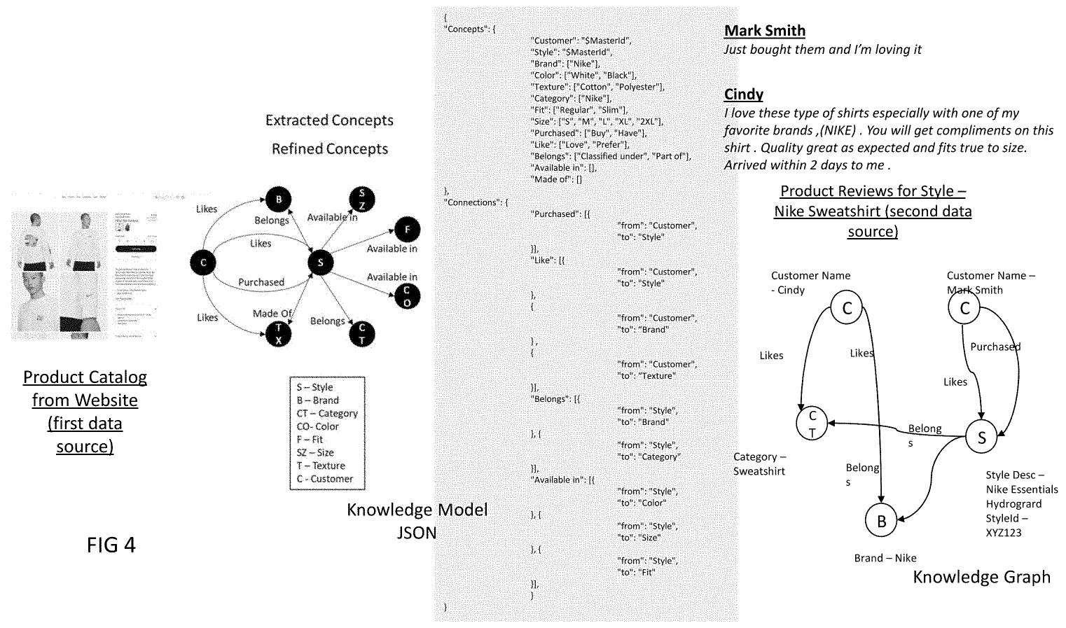

An example of the knowledge model and knowledge graph will now be elaborated along with the description of FIG. 4. For the purpose of this example a product catalog from a website has been provided as an input data source. As per the process explained in the above paragraphs, entities are extracted from the product catalog, and are synthesized. They are then classified into concepts or connectors. In this example style, brand, category, color, fir, size, texture, customer were identified as entities. Likes, Purchase, belong were classified as connectors. Based on the extracted data and identified entities, knowledge model was created. The knowledge model can show the relation between the concept and the connectors. In the present example, the knowledge model is maintained as a j son file.

The j son file shows the domain value also. For instance, for the concept ‘brand’ the domain value is Nike; for ‘color’ the domain value is white, and black. Similarly the other concepts and domains as shown in the j son file.

In this example once the knowledge model is created, ‘Product Reviews’ is considered as a second data source. Using the knowledge model, and second data source, following data rows can be created—

### Mark Smith Purchased Style #XYZ123

Mark Smith likes Style #XYZ123
Cindy likes Brand Nike
Cindy likes Category Sweatshirts

The above can be stored as rows, and then can be used to prepare the knowledge graph as shown.

Having thus described the basic concept of the invention, it will be rather apparent to those skilled in the art that the foregoing detailed disclosure is intended to be presented by way of example only, and is not limiting. Various alterations, improvements, and modifications will occur and are intended to those skilled in the art, though not expressly stated herein. These alterations, improvements, and modifications are intended to be suggested hereby, and are within the spirit and scope of the invention. Additionally, the recited order of processing elements or sequences, or the use of numbers, letters, or other designations therefore, is not intended to limit the claimed processes to any order except as may be specified in the claims. Accordingly, the invention is limited only by the following claims and equivalents thereto.

What is claimed is:

1. A method for knowledge extraction from heterogeneous data sources comprising,
extracting, by a computing device, one or more concepts from a first one or more heterogeneous data sources, using a first one or more pre-existing knowledge structure;
identifying, by the computing device, relation between the extracted concepts using the first data sources and the pre-existing first knowledge structure;
creating, by the computing device, a first knowledge structure using the identified relations;
extracting, by the computing device, one or more entities from a second one or more data source, and mapping the extracted entities to the extracted concepts and the identified relations, using the created first knowledge structure, wherein the second data source is associate with the first data source;
converting, by the computing device, the mapping of the entities into one or more data structures and;
creating, by the computing device, a second knowledge structure from the converted data structures.

2. The method as claimed in claim 1, wherein the first knowledge structure is created using the identified relation between extracted concepts.

3. The method as claimed in claim 2, wherein the pre-existing first knowledge structures are augmented with the created first knowledge structure.

4. The method as claimed in claim 1, further comprising identifying, by the computing device, a set of values related to the extracted concepts from the data source.

5. The method of claim 1, further comprising removing, by the computing device, noise from the sources for extracting the concepts.

6. A cognitive platform for knowledge extraction from heterogeneous data sources comprising a processor and a memory comprising instructions executable by the processor to cause the system to perform operations comprising:
extracting one or more concepts from a first one or more heterogeneous data sources, using a first one or more pre-existing knowledge structure;
identifying relation between the extracted concepts using the first data sources and the pre-existing first knowledge structure;
creating a first knowledge structure using the identified relations;
extracting one or more entities from a second one or more data source, and mapping the extracted entities to the extracted concepts and the identified relations, using the created first knowledge structure, wherein the second data source is associate with the first data source;
converting the mapping of the entities into one or more data structures and;
creating a second knowledge structure from the converted data structures.

7. The platform as claimed in claim 6, wherein the first knowledge structure is created using the identified relation between extracted concepts.

8. The platform as claimed in claim 7, wherein the pre-existing first knowledge structures are augmented with the created first knowledge structure.

9. The platform as claimed in claim 6, further comprising identifying a set of values related to the extracted concepts from the data source.

10. The platform as claimed in claim 6, further comprising removing noise from the sources for extracting the concepts.

11. A non-transitory computer readable medium with instructions stored thereon that, when executed by a processor, cause the processor to perform operations comprising:
extracting one or more concepts from a first one or more heterogeneous data sources, using a first one or more pre-existing knowledge structure;
identifying relation between the extracted concepts using the first data sources and the pre-existing first knowledge structure;
creating a first knowledge structure using the identified relations;
extracting one or more entities from a second one or more data source, and mapping the extracted entities to the extracted concepts and the identified relations, using the created first knowledge structure, wherein the second data source is associate with the first data source;
converting the mapping of the entities into one or more data structures and;
creating a second knowledge structure from the converted data structures.

12. The non-transitory computer readable medium as claimed in claim 11, wherein the first knowledge structure is created using the identified relation between extracted concepts.

13. The non-transitory computer readable medium as claimed in claim 12, wherein the pre-existing first knowledge structures are augmented with the created first knowledge structure.

14. The non-transitory computer readable medium as claimed in claim 11, further comprising identifying a set of values related to the extracted concepts from the data source.

15. The non-transitory computer readable medium of claim 11, comprising removing noise from the sources for extracting the concepts.
